(19) United States
(12) Patent Application Publication
(10) Pub. No.: US 2025/0217268 A1
(43) Pub. Date: Jul. 3, 2025

(54) MULTIPLE SIMULTANEOUS CODE DEBUGGING

(71) Applicant: MICROSOFT TECHNOLOGY LICENSING, LLC, Redmond, WA (US)

(72) Inventors: Lior ELBAZ, Givon Hahadasha (IL); Vladimir PERELMAN, Tel Aviv (IL); Meital BEN DAVID, Tel Aviv (IL)

(21) Appl. No.: 18/397,996

(22) Filed: Dec. 27, 2023

(51) Int. Cl. G06F 11/36; G06F 8/71

(52) U.S. Cl. CPC G06F 11/3624; G06F 8/71

(57) ABSTRACT

Disclosed is a technique for debugging different versions of a software application, each associated with a different branch of a source code base. A debugger simultaneously debugs the different versions, synchronizing execution while highlighting differences between them. Execution is synchronized by stepping to and setting breakpoints on logically corresponding points of execution. For example, a single “step” command may cause both versions to step to the same logical code location. Similarly, a single “insert breakpoint” command may cause breakpoints to be placed at the same logical code location in both versions. Corresponding logical points of execution may be determined by comparing source code branches and application binaries of the different versions. Differences between the versions may be displayed visually, including changes to source code and changes to the binary executables. While execution is paused in the debugger, mappings from old to new function and variable names may be visualized.

### BACKGROUND

In software development, programmers frequently store source code in a version control system. Version control systems manage changes to source code over time, enable multiple programmers to collaborate on the same source code, and allow different versions of the source code to co-exist. Different versions of the source code are stored in different branches. This allows new features to be developed in a separate branch from the main branch of the source code.

It is often beneficial to compare different versions of the software generated from different branches of the source code. For example, execution of an application binary built from a new feature branch may be compared with execution of an application binary built from the stable branch. This comparison is useful for identifying discrepancies, ensuring compatibility, and debugging.

However, existing techniques for comparing execution flows of different versions of a software application have significant limitations. One technique runs multiple instances of developer tools side-by-side, while another technique runs them in series. Running multiple instances of developer tools side-by-side is resource intensive. On top of this is the burden to the programmer of jumping back and forth between the developer tools, which takes time and causes the programmer to lose their place. Sequential instances suffer from the mental burden of remembering relevant details from one session to the next, compounded by the inability to alter the first session while in the second session.

It is with respect to these and other considerations that the disclosure made herein is presented.

### SUMMARY

Disclosed is a technique for debugging different versions of a software application, each associated with a different branch of a source code base. A debugger simultaneously debugs the different versions, synchronizing execution while highlighting differences between them. Execution is synchronized by stepping to and setting breakpoints on logically corresponding points of execution. For example, a single “step” command may cause both versions to step to the same logical code location. Similarly, a single “insert breakpoint” command may cause breakpoints to be placed at the same logical code location in both versions. Corresponding logical points of execution may be determined by comparing source code branches and application binaries of the different versions. Differences between the versions may be displayed visually, including changes to source code and changes to the binary executables. While execution is paused in the debugger, mappings from old to new function and variable names may be visualized.

Features and technical benefits other than those explicitly described above will be apparent from a reading of the following Detailed Description and a review of the associated drawings. This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “techniques,” for instance, may refer to system(s), method(s), computer-readable instructions, module(s), algorithms, hardware logic, and/or operation(s) as permitted by the context described above and throughout the document.

### BRIEF DESCRIPTION OF THE DRAWINGS

The Detailed Description is described with reference to the accompanying figures. In the figures, the left-most digit(s) of a reference number identifies the figure in which the reference number first appears. The same reference numbers in different figures indicate similar or identical items. References made to individual items of a plurality of items can use a reference number with a letter of a sequence of letters to refer to each individual item. Generic references to the items may use the specific reference number without the sequence of letters.

FIG. 1 illustrates branches of source code maintained by a version control system.

FIG. 2A illustrates selecting branches for multiple simultaneous debugging.

FIG. 2B illustrates stepping into two versions of the same application.

FIG. 2C illustrates synchronized stepping from one pair of corresponding points of execution to another pair of corresponding points of execution.

FIG. 2D illustrates synchronously evaluating an expression in both versions of the application.

FIG. 2E illustrates synchronously stepping into different versions of a function.

FIG. 2F illustrates synchronously inserting a breakpoint into both versions of the application.

FIG. 2G illustrates performing an unsynchronized step-in command with one of the two application versions.

FIG. 2H illustrates performing an unsynchronized step-out command with one of the two application versions.

FIG. 2I illustrates a synchronized step-into command that passes through an intermediate function in one of the versions until a shared logical execution point is reached.

FIG. 2J illustrates a synchronized run to a shared breakpoint.

FIG. 3 Illustrates processing source code from both branches and analyzing corresponding binary executables to generate corresponding points of execution.

FIG. 4 is a flow diagram of an example method for multiple simultaneous code debugging.

FIG. 5 is a computer architecture diagram illustrating an illustrative computer hardware and software architecture for a computing system capable of implementing aspects of the techniques and technologies presented herein.

### DETAILED DESCRIPTION

Version control branches have many benefits, such as isolating the development of individual software features. Once a feature has been completed, the branch it was developed in may be integrated back into the main branch for release. Often, while working in one branch, a developer will encounter a defect that does not appear in another branch of the same codebase. One technique for locating the root cause of the defect is to compare execution of both branches, starting with the same inputs and proceeding until the discrepancy is found.

The disclosed embodiments enable side-by-side execution of different versions of the same software application within a single debugger. The debugger launches both versions and/or attaches to both versions of the application. Execution of the two versions is synchronized to logically similar points of execution-statements, instructions, or other units of execution that perform the same or similar functionality in the different versions. For example, in response to a step command the debugger may step both versions of the application until they both reach logically similar points of execution.

Another example of synchronized execution occurs in response to a “step out” command received by the debugger. A step-out command resumes execution until the current function returns. However, as source code evolves in different branches, function names change, code may be added to or removed from a function, a function may be refactored into multiple functions or vice-versa, etc. As such, even if both versions of the application have paused execution in function A, it is possible that function A was called by different functions in different versions of the application. For example, one branch may return to function B, while another branch returns to function C which returns to function B. When stepping out, the user may choose to synchronize execution by stepping to the next corresponding points of execution-function B in this example. The debugger would then step both versions of the application until both reached the corresponding points of execution in function B.

Debugger commands, such as step, step-out, and create breakpoint, explicitly or implicitly include a target within the application. The target may be a combination of source code file name and line number, such as a create breakpoint command that targets a particular file and line. The target may also be a memory address of the application being debugged, such as the address of a function to step to. Other types of targets, as well as other debugger commands, are similarly contemplated.

Source code comparison and binary comparison of the application binaries may be used to identify logically corresponding points of execution of the different versions. Both comparisons contribute to the overall understanding of differences between the versions. For example, a source code comparison may quickly reveal that little if anything has changed within a source code file. In this scenario, a 1:1 mapping may be made between points of execution in that file. However, as changes are made to that file, such as re-ordering functions, renaming functions and variables, refactoring code into additional or different functions, etc., it becomes more difficult to maintain a correspondence between the different versions of the file using source code comparison. Even a subtle change, such as unrolling a loop, may confuse a source code analyzer. In some configurations the source code analysis includes a lexical “diff”, parsing the source code into syntax trees for comparison, or analysis by a machine learning model.

A comparison of binary executables of the different versions may identify corresponding points of execution that a source comparison alone would miss. For example, binary executables strip away variable and function names, and so corresponding points of execution may be identified in spite of these changes to the source code. Similarly, a binary comparison may identify when source code has been moved to a different location. Sometimes, a function remains the same, but changes to remote code or changes to the tool chain changes how the function compiles. For example, a change to global state may affect how a control flow statement is optimized, affecting the generated assembly language, even though the source code remains unchanged. A binary comparison of the application binaries reveals these changes. In some configurations, a binary comparison identifies entry and exit points of a function as corresponding points of execution, as these locations tend to remain stable even if there is significant change to the function itself.

The source code analysis and binary executable analysis discussed herein may be applied to any programming language or any software platform. Source code comparison may be tailored to particular languages, while binary comparison may be tailored to particular operating systems or runtimes. For interpreted languages, such as Python, there would not be a binary compare.

Corresponding points of execution may be highlighted visually by the debugger. A dense series of logically corresponding points of execution may indicate similar functionality in both branches. Sparser corresponding points of execution may indicate greater divergence of functionality. Some corresponding points of execution may be the last point along a path of execution that the two versions share, after which the versions diverge. Highlighting this divergence may itself be valuable to the user.

In situations when the path of execution diverges, the debugger may ask the user to identify points of execution in both versions to step to next. For example, in response to a step command, the debugger may ask the user to select from a list of potential shared points of execution for one or both versions of the application. Additionally, or alternatively, the debugger may prompt the user to manually identify the next point of re-convergence.

The debugger supports simultaneous expression evaluation. Expression evaluation allows a user to evaluate source code while the debugger has paused execution. Simultaneously evaluating both versions of the application allows a user to quickly find where a discrepancy may first appear. For example, the user may evaluate the expression “X+Y”, to which the debugger responds by adding the value of the variable X with the value of the variable Y and displaying the result. However, variables can be renamed, complicating the user's attempt to evaluate an expression in both versions of the application. To address this, mappings of variable names between the versions may be applied to evaluate a single expression in both versions of the application. For example, if Y is renamed to Z in one of the branches, then the expression “X+Y” may be transformed to “X+Z” for evaluation in that branch.

The amount of change between branches can vary significantly. In some cases a source code file remains completely or essentially unchanged. Some changes add or remove functions while leaving the functionality of the code unchanged, such as refactoring a common piece of code out of two functions into a separate function. Intrusive code changes, such as reworking an algorithm, may make it difficult if not impossible to map execution points between the branches.

Often the corresponding location will exist at a different line number in the other branch. The corresponding location may also be in a different function, or even a different file. When no logical equivalence between lines can be found, the user may be prompted to manually identify the corresponding line.

In some configurations, the debugger highlights the corresponding points of execution, enabling the user to visualize when execution between the versions diverges and when it re-converges.

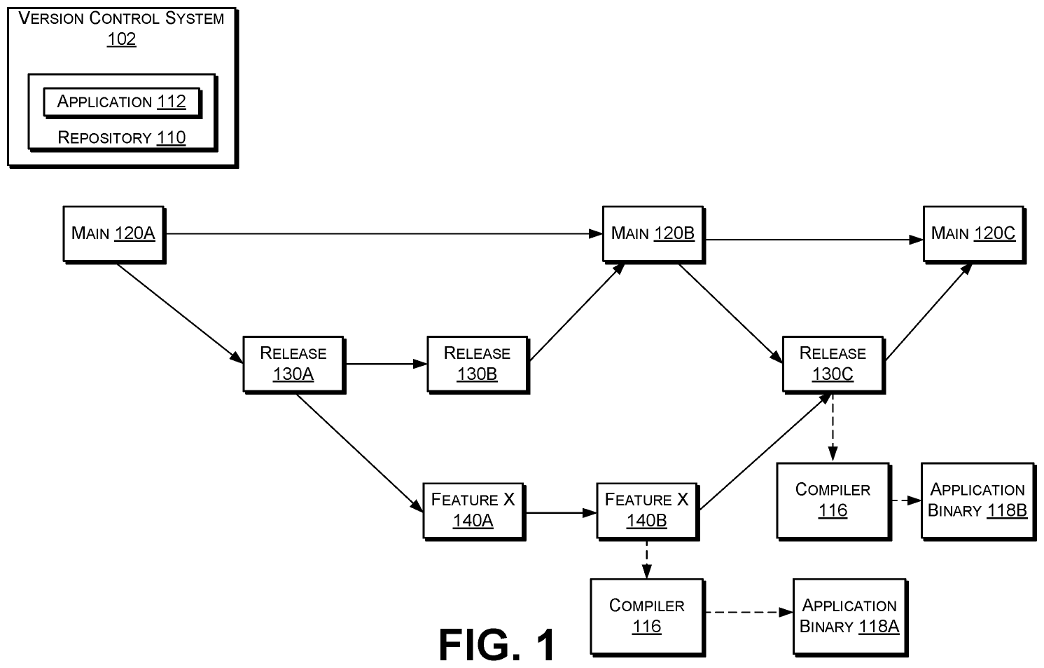

FIG. 1 illustrates branches of source code maintained by a version control system. Version control system 102, such as a GIT service, may host one or more repositories. Repository 110 contains source code used to build application 112. Repository 110 maintains multiple branches of source code usable to build application 112. Each branch allows isolated development, such that changes in one branch do not affect code stored in another branch.

Main branch 120, release branch 130, and feature X branch 140 are illustrated. Main branch 120 is the first branch, and release branch 130 is initially forked from main branch 120. Feature X branch 140 is initially forked from release branch 130. Main 120A, 120B, and 120C represent changes made to main branch 120. Similarly, release 130A, 130B, and 130C and feature X 140A and 140B represent changes to branches 130 and 140, respectively.

Branches 120, 130, and 140 merge where multiple arrows point to a single change. For example, main 120A and release 130B are merged into main 120B. Main 120B and feature X 140B are merged into release 130C, which merges with main 120B at main 120C. The particular branches, forks, and merges of repository 110 are illustrative and not limiting.

Each branch of repository 110 may be used to build a different version of application 112. Compiler 116 may convert each version of application 112 into a distinct application binary 118 that executes application 112. Compiler 116 may at the same time create debug symbol information that maps computer instructions within application binary 118 to the line of source code that generated those instructions. In this way, a symbolic debugger is able to step, set breakpoints, and perform other commands at the level of source code lines and source code instructions instead of assembly language instruction addresses.

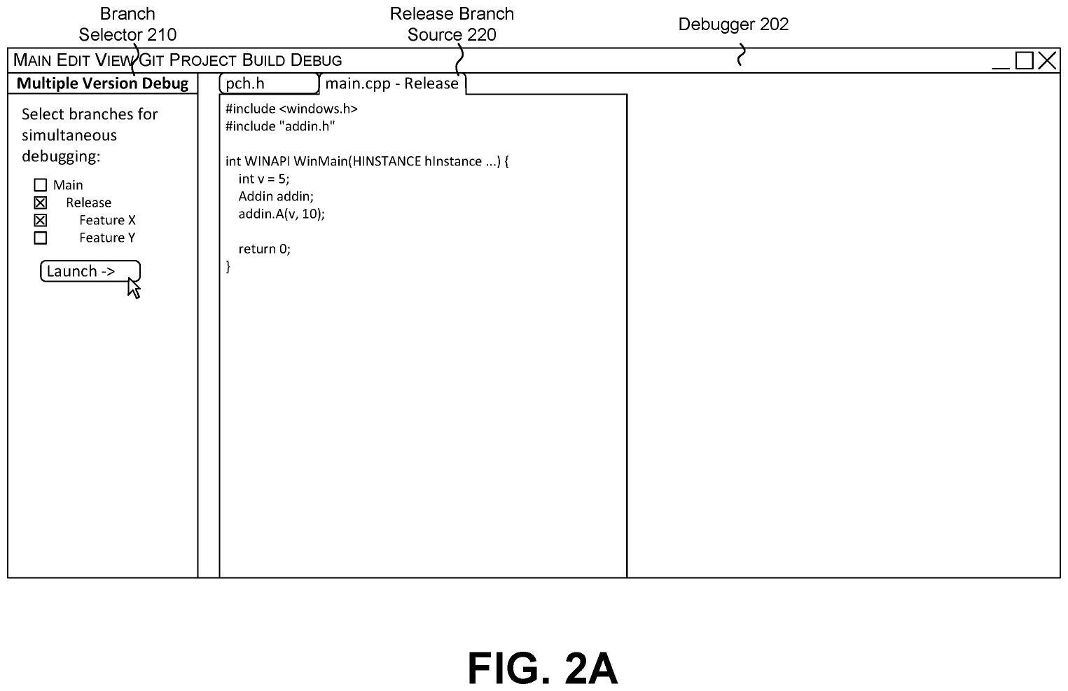

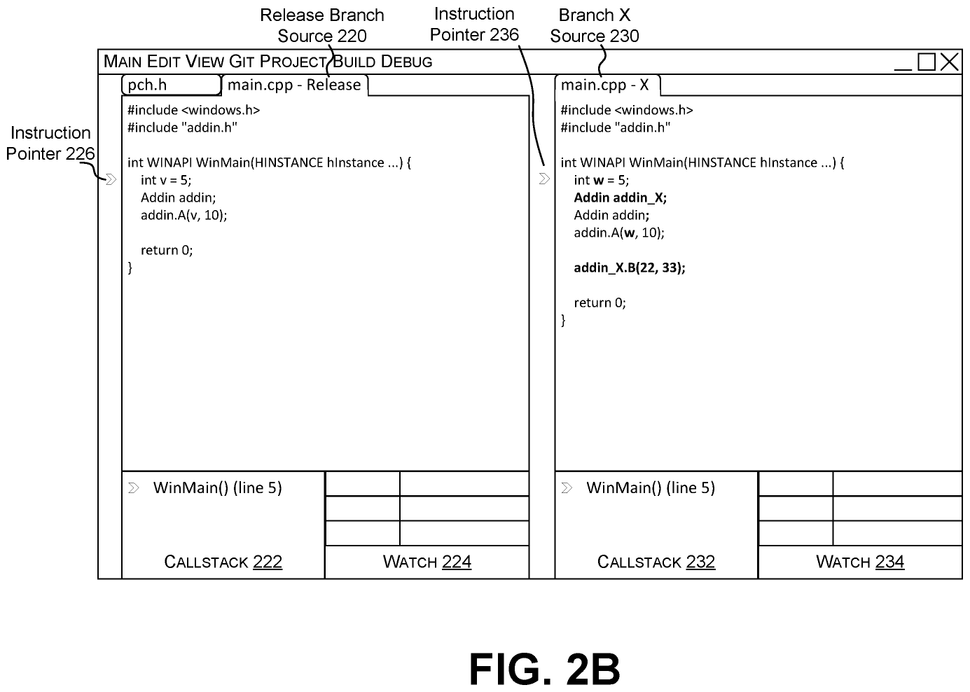

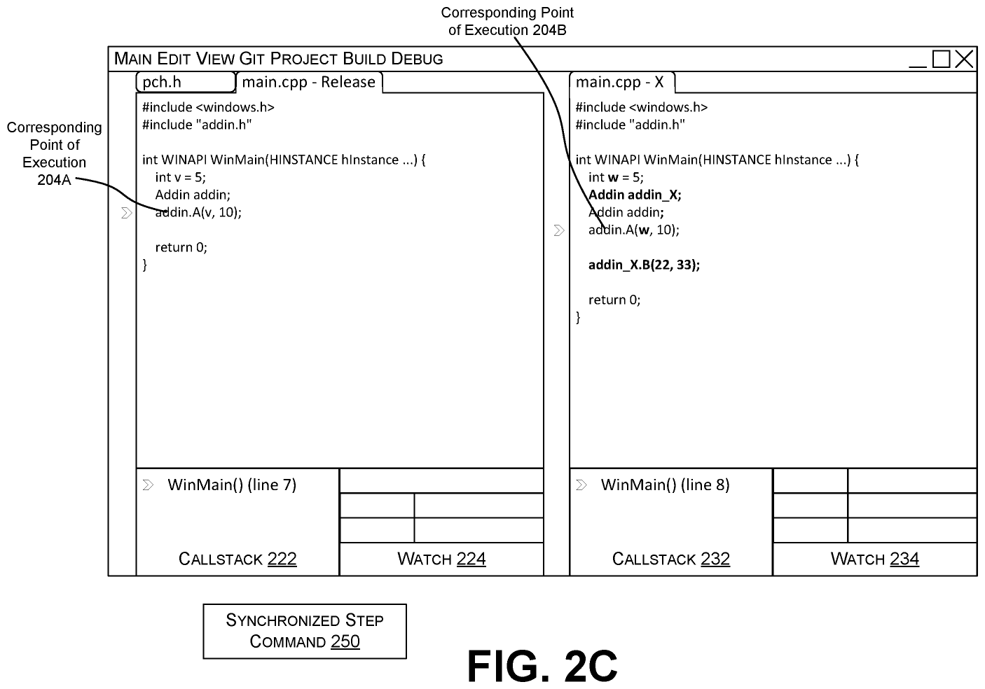

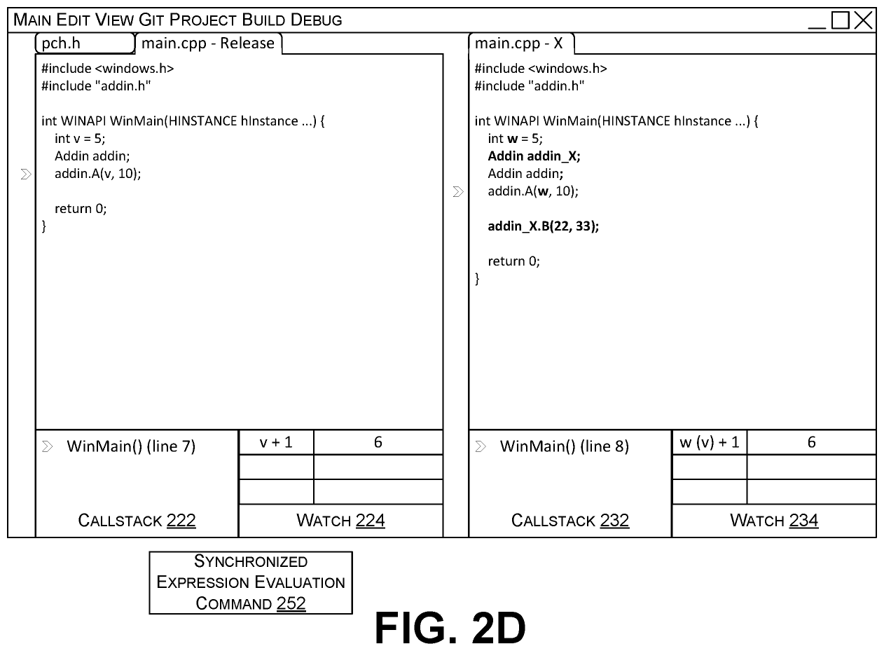

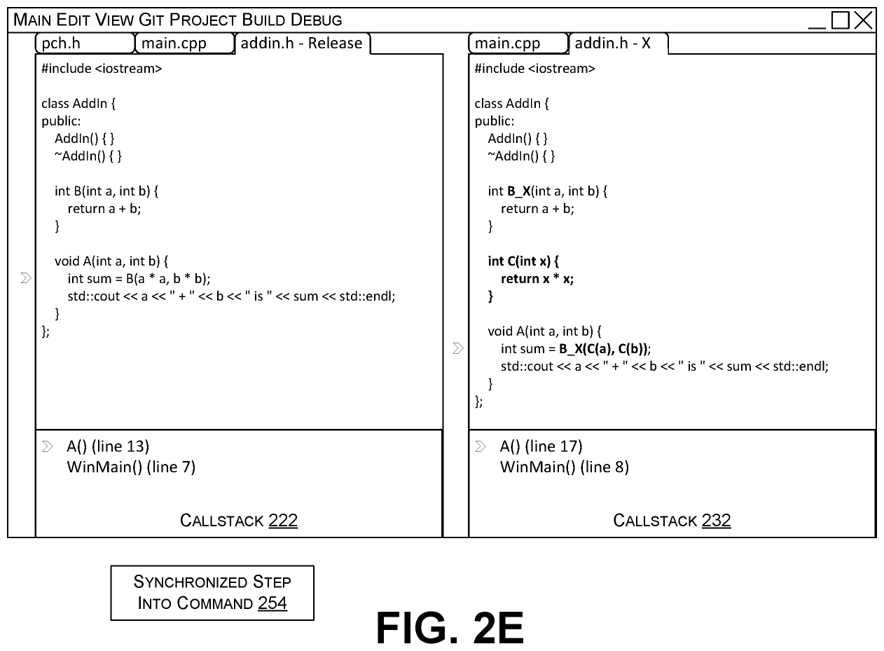

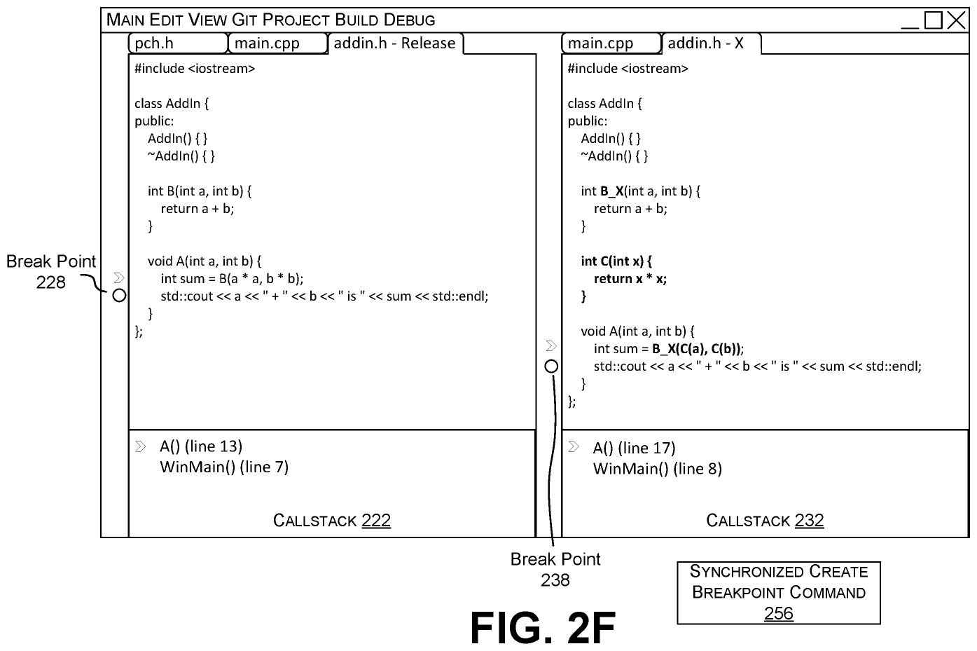

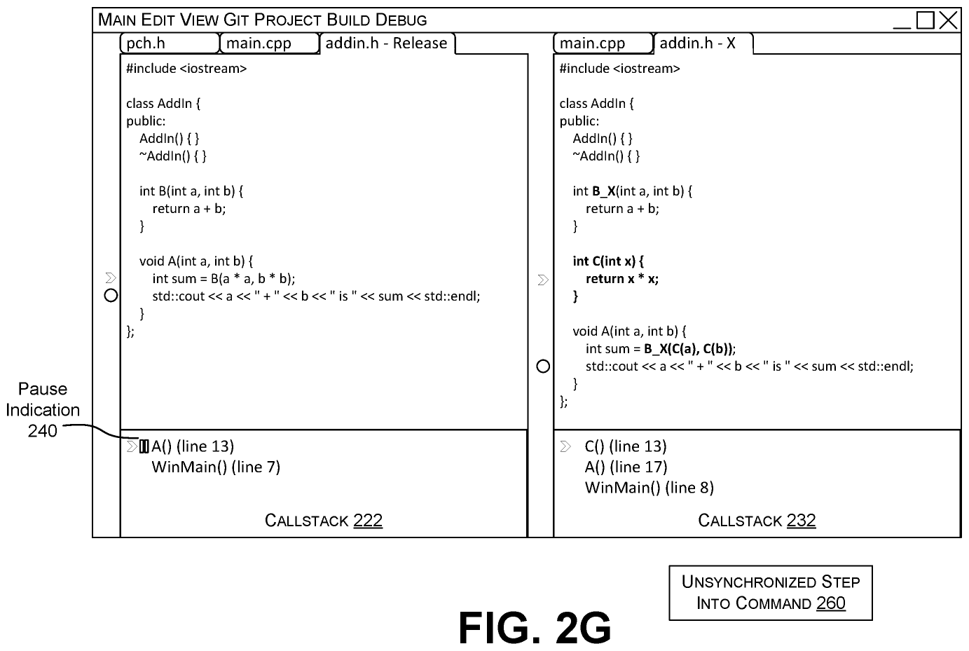

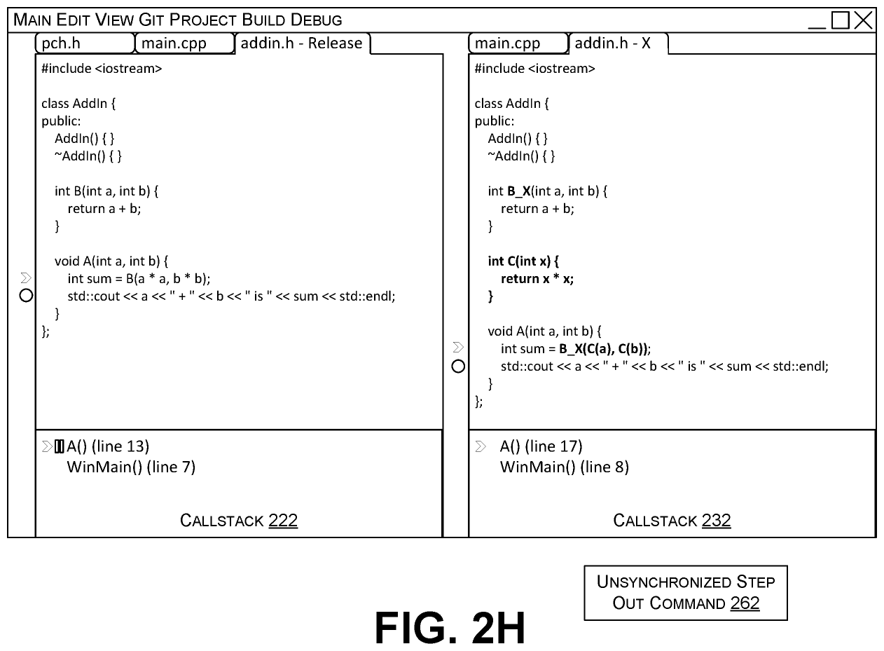

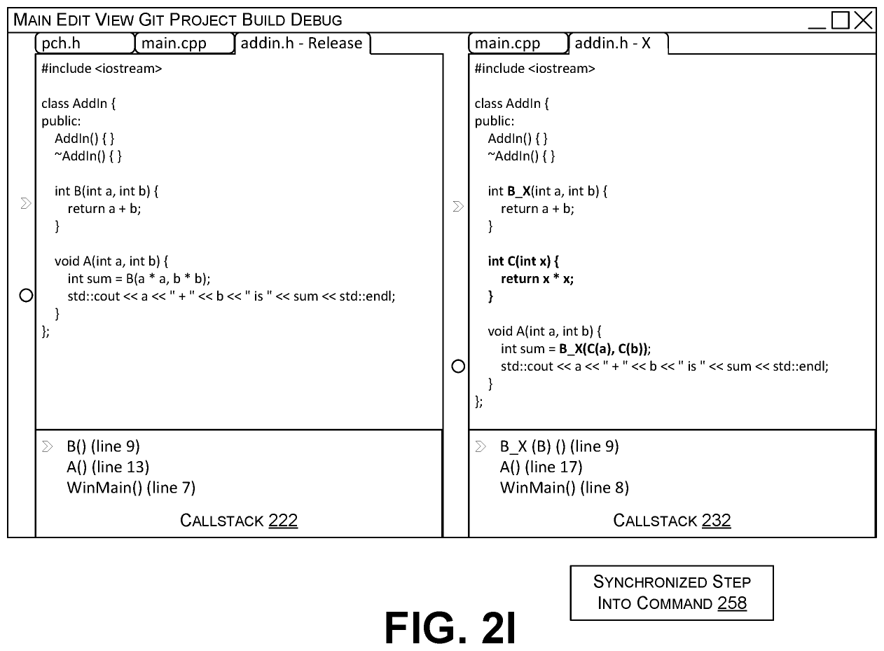

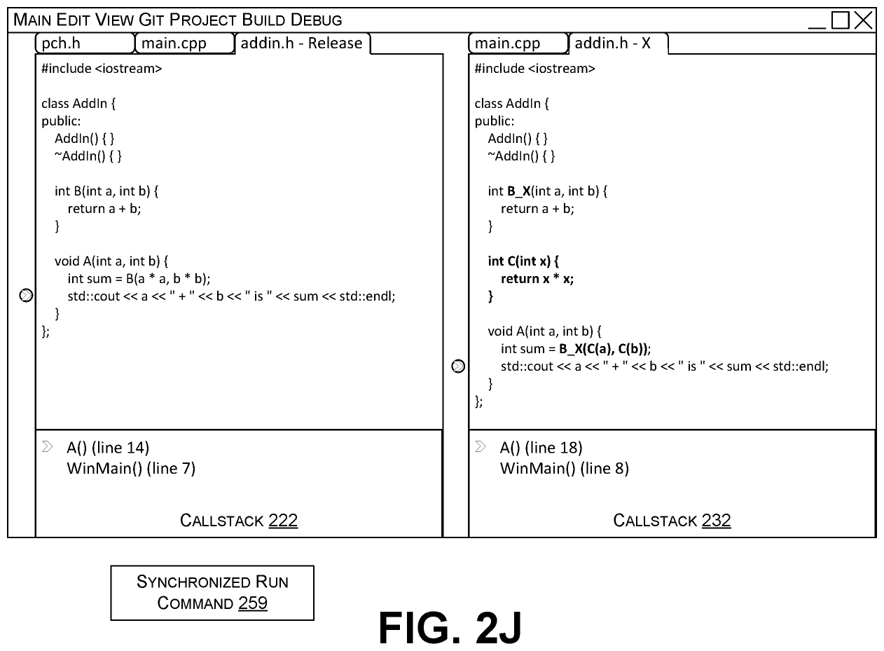

FIG. 2A illustrates selecting branches for multiple simultaneous debugging. Branch selector interface 210 is presented within debugger 202. However, branch selector 210 may be a separate application or appear without debugger 202. Debugger 202 displays release branch source 220—the main.cpp file. The disclosed embodiments are program language neutral, and are just as applicable to C, Rust, or other languages. Similarly, the disclosed embodiments are platform neutral, and can be applied to bytecode based languages such as JAVA and C#, as well as interpreted languages such as PYTHON.

Branch selector 210 may retrieve a list of available branches from repository 110. As illustrated, the main branch 120, release branch 130, feature X branch 140, and feature Y branch are listed. Branch selector 210 lists the branches hierarchically, but a flat list or other technique for presenting a list of items for selection is similarly contemplated. As illustrated, a user may activate a launch button to launch versions of application 112 for simultaneous debugging. In some configurations, the selected versions of application 112 are compiled from source code before launching, although branch selector 210 may also retrieve pre-built binary executables and debug symbols from a central repository.

FIG. 2B illustrates stepping into two versions of the same application. Ordinarily, a debugger launches and pauses execution in a single application. Some debuggers are capable of debugging multiple processes at the same time, but each debuggee is a different application, not different versions of the same application. As such, existing multi-process debuggers do not support the disclosed capabilities of synchronous execution of different versions of the same application. For example, existing multi-process debuggers do not identify logically similar points of execution across different processes and enable stepping to these corresponding points of execution with a single command.

In some configurations, while launching simultaneous debugging, branch X source 230 is displayed in addition to release branch source 220. Branch X source 230 may be obtained from repository 110. Debugger 202 launches both versions of application 112. As illustrated, debugger 202 pauses execution at the entry point—the first user-generated code. The instruction that the debugger is stopped at is indicated by instruction pointer 226 for the release branch 130 and instruction pointer 236 for the feature X branch 140.

Branch X source 230 indicates with bold text what has changed compared to release branch source 220. Changes may be identified based on a source code comparison, e.g. a diff, parsing the source code 230 and 220 into parse trees for comparison, using a machine learning model, or the like.

Changes may also be identified based on a comparison of the binary executables 118 of the different versions of application 112. A binary comparison may identify functions with the executable, function names, loops, variables, groups of instructions, and other portions of application 112. Once a change has been observed between the different versions of the binary executable, debug information may be used to determine what source code caused the change. In some configurations, a change may occur to the binary executable of application 112 due to a change to a remote piece of source code, while the source code that is associated with the changed portion of the binary is itself unchanged. This may occur, for example, when a global variable changes a control path of a function, leading to different code generation for source code that is otherwise unchanged. Another example occurs when remotely defined code changes, such as an inlined function, cause the binary executable to change while the local source code remains the same.

FIG. 2B also introduces multiple callstacks and watch windows, one for each version of application 112. Callstack 222 is associated with release branch 130, and indicates that execution was paused in the WinMain function at line 5. Similarly, callstack 232 illustrates that, in branch X source 230, execution was also paused at line 5 of the WinMain function. Watch windows 224 and 234 are not used in FIG. 2B.

Main.cpp is an example of a file that has not changed much, in absolute or percentage terms, between versions. Specifically, the code is more or less the same, but the feature X branch has an additional object “Addin addin_X;” that has been added, and the “B” function is invoked on this object “addin_X.B(22, 33);”. The number and types of changes to main.cpp could be adequately identified by source code comparison alone or binary comparison alone, although both source code comparison and binary comparison could be applied to the corresponding versions of application 112.

FIG. 2C illustrates synchronized stepping from one pair of corresponding points of execution to another pair of corresponding points of execution. Synchronized step command 250 is received by debugger 202, causing debugger 202 to step through each version of application 112 line by line—or expression by expression—until logically corresponding points of execution are reached.

As illustrated, corresponding points of execution 204 are found on lines 7 and 8 of the release and feature X branches, respectively. Points of execution in this example are lines of code in a source code file, but it is similarly contemplated that a point of execution represents a statement, an expression, or an instruction. For example, application 112 may be broken down into semi-colon delimited statements, comma-delimited expressions, or individual machine instructions, or a combination thereof.

Debugger 202 may determine that points of execution 204 correspond because a source code comparison indicates they are similar—the only difference being the renaming of the first argument from ‘v’ to ‘w’. A binary comparison may also determine the correspondence based on the name of the function being invoked—both versions invoke the “A( )” method of the Addin class. However, other techniques for determining correspondences are similarly contemplated.

FIG. 2D illustrates synchronously evaluating an expression in both versions of the application. In some configurations, debugger 202 receives synchronized expression evaluation command 252. This command includes an expression to be evaluated by debugger 202. As illustrated the expression is “v+1”. Debugger 202 my inspect the state of the version of application 112 associated with release branch 130 to determine that “int v” has the value of 5. The expression evaluator may evaluate the remaining expression “5+1”, yielding the result “6” in watch window 224.

Often a user would like to evaluate the same expression in both versions of application 112. However, changes to the source code over time may make a direct evaluation inappropriate. As in this example, “int v” has been renamed to “w”, and so debugger 202 would fail to evaluate the expression “v+1” naively.

In order to enable evaluation of a single expression in both versions of application 112, debugger 202 may translate the expression to use current variable names. In this example, an analysis of the different versions reveals that variable “v” has been renamed to “w”, and so it changes the expression “v+1” to “w+1” for evaluation in the feature X version. The result, “6”, is displayed in watch window 234. In some configurations, watch windows display the renaming that was performed, as indicated by “(v)” in the “w (v)+1” expression that was automatically entered into watch window 234.

FIG. 2E illustrates synchronously stepping into different versions of a function. Synchronized step-into command 254 causes debugger to step from lines 7 and 8 of main.cpp into method “A” of class AddIn. As illustrated in callstacks 222 and 232, the release version of application 112 stopped on line 13 of addin.h, while the feature X version stopped on line 17 of addin.h. The correspondence between line 13 of the release branch 130 of addin.h and line 17 of the feature X branch 140 of addin.h may be determined based on a source code analysis that uses file name, class name, and function name, and function contents to estimate that function “A” of feature X branch 140 evolved from function “A” of release branch 130. The correspondence may also be determined by identifying instructions that are unique to function “A”, such as the “std::cout” statement.

FIG. 2F illustrates synchronously inserting a breakpoint into both versions of the application. Synchronized create breakpoint command 256 may include a source file name and a line number of one of the branches. For example, synchronized create breakpoint command 256 may refer to “addin.h” and “line 18” of feature X branch 140. Debugger 202 looks up a corresponding point of execution for the release branch 130, finding a corresponding file “addin.h” and “line 13”. Debugger 202 then uses unsynchronized create breakpoint commands in each version to create breakpoints on the identified lines of each branch.

FIG. 2G illustrates performing an unsynchronized step-in command with one of the two application versions. Unsynchronized step into command 260 indicates to debugger 202 to step one version of application 112 but not another. Typically, two versions of application 112 are debugged at once, although this can be extended to any number of versions, in which case debugger 202 may allow a user to select which versions to apply the command.

Unsynchronized step into command 260 is associated with feature X branch 140. Accordingly, pause indication 240 appears in callstack 222, indicating that the version associated with release branch 130 has not changed. Specifically, the instruction pointer remains at line 13 of addin.h, and it has not moved in response to unsynchronized step into command 260. Unsynchronized step into command 260 performs a traditional step into command, common to debuggers that debug one application at a time. The operation performed by unsynchronized step into command 260 is similar to if not the same as the sub-operation used to iteratively step versions of application 112 to perform a synchronized step.

As illustrated, the feature X branch 140 has stepped into function C, which has been refactored out of function “A”. Specifically, while the function “A” of release branch 130 computes a square by directly multiplying “a*a” and “b*b”, function “C” was introduced to perform this operation. Accordingly, unsynchronized step into command 260 steps into function “C” for the first time, to compute “a*a”.

FIG. 2H illustrates performing an unsynchronized step-out command with one of the two application versions. Unsynchronized step out command 262, similar to unsynchronized step into command, steps the selected version of application 112—feature X branch 140 as illustrated. In response, debugger 202 steps out of function “C” back into function “A”. Callstack 232 returns to its previous state. While FIGS. 2G and 2H illustrate unsynchronized stepping of feature X branch 140, the commands could be applied to any individual branch.

FIG. 2I illustrates a synchronized step-into command that passes through an intermediate function in one of the versions until a shared logical execution point is reached. Synchronized step into command 258 causes a synchronized step similar to synchronized step command 250. In this instance, the version of application 112 associated with feature X branch 140 had just returned from the first invocation of function “C”. Before stepping in to function “B_X”, this version first steps through function “C” a second time—when “b” is the parameter to function “C”. The version of application 112 built from release branch 130, in contrast, steps directly to function “B”.

Debugger 202 has inferred from corresponding points of execution that an association exists between function “B” of release branch 130 and function “B_X” of feature X branch 140. This association may be based on the functionality, which is identical, the number and type of parameters, the location within addin.h and the location relative to other functions, and the lexical similarity of their names. Another factor is the similar locations of their call sites—both are invoked by the first line of function “A”.

In some configurations, the association between function “B” of release branch 130 and function “B_X” of feature X branch 140 may be identified by a comparison of the binary executables 118 of the corresponding versions of application 112. For example, a call graph beginning with WinMain may match between the different versions, and “B” and “B_X” may be located in the same or similar positions in the call graph.

FIG. 2J illustrates a synchronized run to a shared breakpoint. Synchronized run command 259 is received by debugger 202. Debugger 202 allows both versions of application 112 to run, which in this example results in release version 130 hitting breakpoint 228 and feature X version 140 hitting breakpoint 238. In some configurations, if one version of application 112 breaks more than a defined period of time before the other, debugger 202 may allow inspection of local variables, expression evaluation, and other debugging operations targeting that version. In some configurations both versions of application 112 must be paused before another synchronized debugger command can be processed.

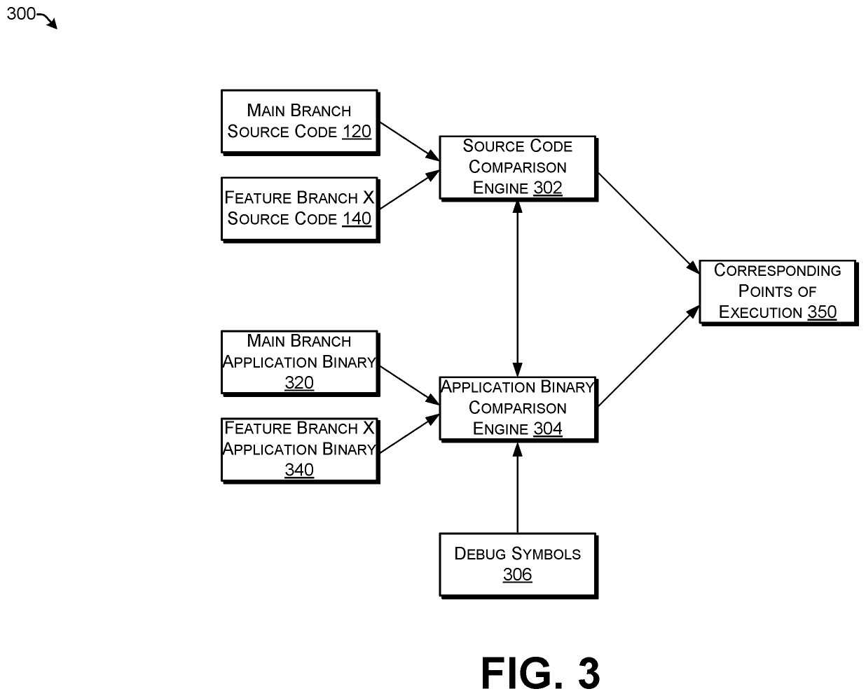

FIG. 3 Illustrates processing source code from both branches and analyzing corresponding binary executables to generate corresponding points of execution. Source code comparison engine 302 compares main branch source code 120 and feature branch X source code 140 to identify corresponding points of execution 350, as discussed herein. Similarly, application binary comparison engine 304 compares main branch application binary 320 with feature branch X application binary 340 to identify corresponding points of execution 350. Debug symbols 306 may be used to map corresponding points of execution identified by application binary comparison engine 304 to the file and line of the source code they were built from.

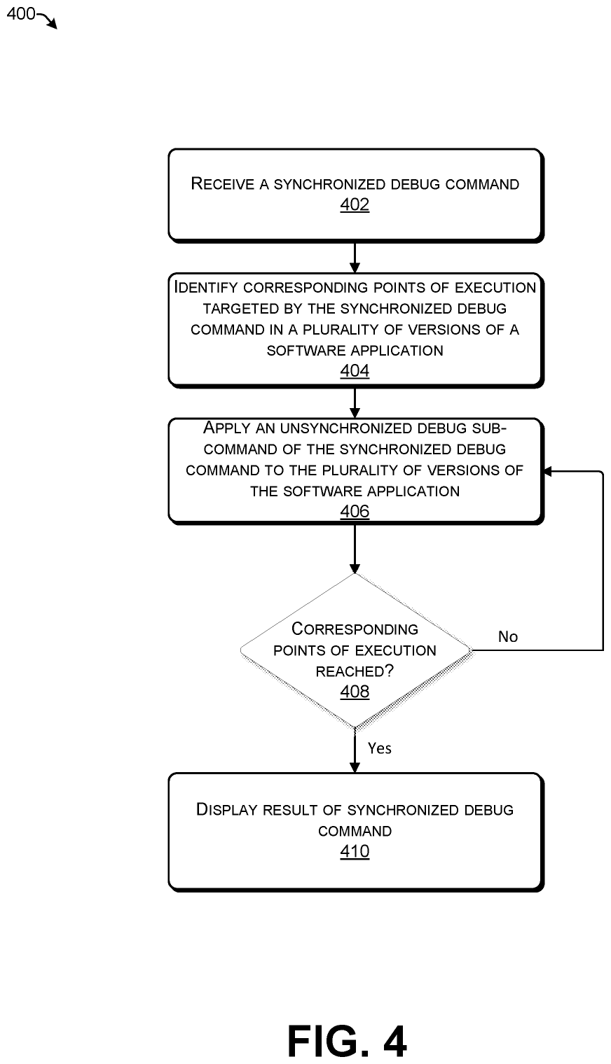

FIG. 4 is a flow diagram of an example method for a multiple simultaneous code debugging. Routine 400 begins at operation 402, where a synchronized debug command is received. For example, synchronized step command 250, synchronized create breakpoint command 256, or synchronized step into command 258 are commands received by debugger 202 that are applied to multiple versions of application 112 simultaneously.

Next at operation 404, corresponding points of execution 350 targeted by the synchronized debug command are identified. For example, in response to synchronized create breakpoint command 256, debugger 202 finds points of execution in each of the simultaneously debugged versions of 112 that are logically similar. These points of execution could be on the same line in the same file if little to no change has accrued between the versions of application 112. On the other hand, if significant divergence has occurred, debugger 202 may not be able to identify two corresponding points of execution, and so may prompt the user to manually choose a location for one or both break points.

Next at operation 406, unsynchronized debug sub-commands are applied to the versions of application 112 being debugged. In this context a sub-command refers to a debug command that could be applied to an individual application. Typically a sub-command will perform the individual operation implied by the synchronized debug command, such as a create breakpoint sub-command carrying out part of a synchronized create breakpoint command.

Next at operation 408, it is determined whether corresponding points of execution have been reached in each of the versions of application 112. Some synchronized debug commands, such as creating breakpoints or running to the cursor, are typically “reached” with one sub-command. Other sub-commands, such as stepping, may need to be applied more than once until an identified point of execution is reached. Often, one version of application 112 will have more sub-commands applied than another, such as synchronized step-into command 258. For example, synchronized step-into command 258 performs two steps for feature X branch 140 but only one step for release branch 130. When a corresponding point of execution is not reached, control passes to operation 406. When a corresponding point of execution is reached, control passes to operation 410.

Next, at operation 410, a result of the synchronized debug command is displayed. When stepping the display of debugger 202 may be updated by rendering a instruction pointer, such as instruction pointer 226 or 236, at a location proximate to the line of code where the synchronized debug command stopped. Similarly, a synchronized breakpoint may be displayed visually by rendering a red circle or other indication proximate to the lines of code of the corresponding execution points.

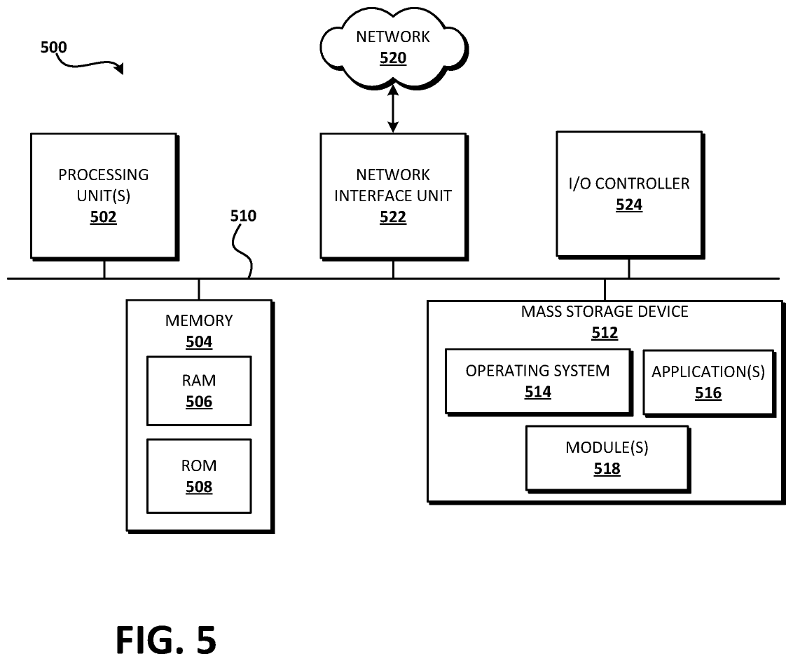

FIG. 5 shows additional details of an example computer architecture 500 for a device, such as a computer or a server configured as part of the systems described herein, capable of executing computer instructions (e.g., a module or a program component described herein). The computer architecture 500 illustrated in FIG. 5 includes processing unit(s) 502, a system memory 504, including a random-access memory 506 (“RAM”) and a read-only memory (“ROM”) 508, and a system bus 510 that couples the memory 504 to the processing unit(s) 502. The processing unit(s) 502 include one or more hardware processors and may also comprise or be part of a processing system. In various examples, the processing unit(s) 502 of the processing system are distributed. Stated another way, one processing unit 502 may be located in a first location (e.g., a rack within a datacenter) while another processing unit 502 of the processing system is located in a second location separate from the first location.

Processing unit(s), such as processing unit(s) 502, can represent, for example, a CPU-type processing unit, a GPU-type processing unit, a neural processing unit, a field-programmable gate array (FPGA), another class of digital signal processor (DSP), or other hardware logic components that may, in some instances, be driven by a CPU. For example, and without limitation, illustrative types of hardware logic components that can be used include Application-Specific Integrated Circuits (ASICs), Application-Specific Standard Products (ASSPs), System-on-a-Chip Systems (SOCs), Complex Programmable Logic Devices (CPLDs), etc.

A basic input/output system containing the basic routines that help to transfer information between elements within the computer architecture 500, such as during startup, is stored in the ROM 508. The computer architecture 500 further includes a mass storage device 512 for storing an operating system 514, application(s) 516, modules 518, and other data described herein.

The mass storage device 512 is connected to processing unit(s) 502 through a mass storage controller connected to the bus 510. The mass storage device 512 and its associated computer-readable media provide non-volatile storage for the computer architecture 500. Although the description of computer-readable media contained herein refers to a mass storage device, it should be appreciated by those tooled in the art that computer-readable media can be any available computer-readable storage media or communication media that can be accessed by the computer architecture 500.

Computer-readable media can include computer-readable storage media and/or communication media. Computer-readable storage media can include one or more of volatile memory, nonvolatile memory, and/or other persistent and/or auxiliary computer storage media, removable and non-removable computer storage media implemented in any method or technology for storage of information such as computer-readable instructions, data structures, program modules, or other data. Thus, computer storage media includes tangible and/or physical forms of media included in a device and/or hardware component that is part of a device or external to a device, including but not limited to random access memory (RAM), static random-access memory (SRAM), dynamic random-access memory (DRAM), phase change memory (PCM), read-only memory (ROM), erasable programmable read-only memory (EPROM), electrically erasable programmable read-only memory (EEPROM), flash memory, compact disc read-only memory (CD-ROM), digital versatile disks (DVDs), optical cards or other optical storage media, magnetic cassettes, magnetic tape, magnetic disk storage, magnetic cards or other magnetic storage devices or media, solid-state memory devices, storage arrays, network attached storage, storage area networks, hosted computer storage or any other storage memory, storage device, and/or storage medium that can be used to store and maintain information for access by a computing device.

In contrast to computer-readable storage media, communication media can embody computer-readable instructions, data structures, program modules, or other data in a modulated data signal, such as a carrier wave, or other transmission mechanism. As defined herein, computer storage media does not include communication media. That is, computer-readable storage media does not include communications media consisting solely of a modulated data signal, a carrier wave, or a propagated signal, per se.

According to various configurations, the computer architecture 500 may operate in a networked environment using logical connections to remote computers through the network 520. The computer architecture 500 may connect to the network 520 through a network interface unit 522 connected to the bus 510. The computer architecture 500 also may include an input/output controller 524 for receiving and processing input from a number of other devices, including a keyboard, mouse, touch, or electronic stylus or pen. Similarly, the input/output controller 524 may provide output to a display screen, a printer, or other type of output device.

It should be appreciated that the software components described herein may, when loaded into the processing unit(s) 502 and executed, transform the processing unit(s) 502 and the overall computer architecture 500 from a general-purpose computing system into a special-purpose computing system customized to facilitate the functionality presented herein. The processing unit(s) 502 may be constructed from any number of transistors or other discrete circuit elements, which may individually or collectively assume any number of states. More specifically, the processing unit(s) 502 may operate as a finite-state machine, in response to executable instructions contained within the software modules disclosed herein. These computer-executable instructions may transform the processing unit(s) 502 by specifying how the processing unit(s) 502 transition between states, thereby transforming the transistors or other discrete hardware elements constituting the processing unit(s) 502.

The particular implementation of the technologies disclosed herein is a matter of choice dependent on the performance and other requirements of a computing device. Accordingly, the logical operations described herein are referred to variously as states, operations, structural devices, acts, or modules. These states, operations, structural devices, acts, and modules can be implemented in hardware, software, firmware, in special-purpose digital logic, and any combination thereof. It should be appreciated that more or fewer operations can be performed than shown in the figures and described herein. These operations can also be performed in a different order than those described herein.

It also should be understood that the illustrated methods can end at any time and need not be performed in their entireties. Some or all operations of the methods, and/or substantially equivalent operations, can be performed by execution of computer-readable instructions included on a computer-storage media, as defined below. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof.

### ILLUSTRATIVE EMBODIMENTS

The following clauses describe multiple possible embodiments for implementing the features described in this disclosure. The various embodiments described herein are not limiting nor is every feature from any given embodiment required to be present in another embodiment. Any two or more of the embodiments may be combined together unless context clearly indicates otherwise. As used herein in this document “or” means and/or. For example, “A or B” means A without B, B without A, or A and B. As used herein, “comprising” means including all listed features and potentially including addition of other features that are not listed. “Consisting essentially of” means including the listed features and those additional features that do not materially affect the basic and novel characteristics of the listed features. “Consisting of” means only the listed features to the exclusion of any feature not listed.

Example 1: A method comprising: receiving a synchronized debug command; identifying corresponding points of execution targeted by the synchronized debug command in a plurality of versions of a software application; applying an unsynchronized debug sub-command of the synchronized debug command to the plurality of versions of the software application until the corresponding points of execution have been targeted by the unsynchronized debug sub-command in the plurality of versions of the software application.

Example 2: The method of example 1, wherein the synchronized debug command comprises a synchronized step command, wherein the unsynchronized debug sub-command comprises an unsynchronized step command, and wherein the unsynchronized step command is applied to the plurality of versions of the software application until the corresponding points of execution are reached.

Example 3: The method of example 1, wherein the synchronized debug command comprises a create breakpoint command, wherein the unsynchronized debug sub-command comprises an unsynchronized create breakpoint command, and wherein the unsynchronized create breakpoint command is applied to the corresponding points of execution of the plurality of versions of the software application.

Example 4: The method of example 1, wherein the plurality of versions of the software application were built from a corresponding plurality of branches of a software repository.

Example 5: The method of example 1, wherein each of the corresponding points of execution comprises an identification of a portion of executable code of one of the plurality of versions of the software application.

Example 6: The method of example 1, wherein the corresponding points of execution evolved from a common point of execution in an independent version of the software application.

Example 7: The method of example 2, wherein the unsynchronized step command is iteratively applied to one of the plurality of versions of the software application to step through an intermediate function not included in another one of the plurality of versions of the software application.

Example 8: A system comprising: a processing unit; and a computer-readable storage medium having computer-executable instructions stored thereupon, which, when executed by the processing unit, cause the processing unit to: receive a synchronized debug command; identify corresponding points of execution targeted by the synchronized debug command in a plurality of versions of a software application; apply an unsynchronized debug sub-command of the synchronized debug command to the plurality of versions of the software application until the corresponding points of execution have been targeted by the unsynchronized debug sub-command in the plurality of versions of the software application.

Example 9: The system of example 8, wherein the corresponding points of execution are obtained by comparing a plurality of branches of source code of the software application that correspond to the plurality of versions of the software application.

Example 10: The system of example 9, wherein comparing the plurality of branches comprises identifying when a function or a variable in one branch has been renamed in another branch.

Example 11: The system of example 8, wherein the corresponding points of execution are obtained by performing a binary comparison of executable binaries of each of the plurality of versions of the software application.

Example 12: The system of example 11, wherein the binary comparison determines that a remote code change or a change in a toolkit used to build the application causes instructions compiled from unchanged local code to change.

Example 13: The system of example 12, further comprising: indicating that the unchanged local code compiles to different instructions in at least one of the versions of the software application.

Example 14: The system of example 11, wherein the binary comparison identifies that a portion of a first function has been moved to a second function, wherein the corresponding points of execution point to the first function in one of the versions of the software application and the second function in another of the versions of the software application.

Example 15: A computer-readable storage medium having encoded thereon computer-readable instructions that when executed by a processing unit cause a system to: receive a synchronized debug command; identify corresponding points of execution targeted by the synchronized debug command in a plurality of versions of a software application; apply an unsynchronized debug sub-command of the synchronized debug command to the plurality of versions of the software application until the corresponding points of execution have been targeted by the unsynchronized debug sub-command in the plurality of versions of the software application.

Example 16: The computer-readable storage medium of example 16, further comprising: displaying a call stack for each of the plurality of versions of the software application.

Example 17: The computer-readable storage medium of example 16, wherein the call stack indicates when a name of a function or a parameter has changed between versions of the software application.

Example 18: The computer-readable storage medium of example 15, further comprising: receiving a synchronized expression evaluation command; translating variable names used in one of the plurality of versions of the software application to another of the plurality of versions of the software application; and evaluating the synchronized expression in both versions of the software application.

Example 19: The computer-readable storage medium of example 15, wherein the synchronized debug command comprises a step into command, a step over command, a step out command, a run to cursor command, or a create breakpoint command.

Example 20: The computer-readable storage medium of example 15, wherein the computer-readable instructions further cause the system to: generate a suggested location of point of execution from a method entry point or a method exit point.

### CONCLUSION

While certain example embodiments have been described, these embodiments have been presented by way of example only and are not intended to limit the scope of the inventions disclosed herein. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions and changes in the form of the methods and systems described herein may be made without departing from the spirit of the inventions disclosed herein. The accompanying claims and their equivalents are intended to cover such forms or modifications as would fall within the scope and spirit of certain of the inventions disclosed herein.

The terms “a,” “an,” “the” and similar referents used in the context of describing the invention are to be construed to cover both the singular and the plural unless otherwise indicated herein or clearly contradicted by context. The terms “based on,” “based upon,” and similar referents are to be construed as meaning “based at least in part” which includes being “based in part” and “based in whole,” unless otherwise indicated or clearly contradicted by context. The terms “portion,” “part,” or similar referents are to be construed as meaning at least a portion or part of the whole including up to the entire noun referenced.

It should be appreciated that any reference to “first,” “second,” etc. elements within the Summary and/or Detailed Description is not intended to and should not be construed to necessarily correspond to any reference of “first,” “second,” etc. elements of the claims. Rather, any use of “first” and “second” within the Summary, Detailed Description, and/or claims may be used to distinguish between two different instances of the same element.

In closing, although the various techniques have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

Furthermore, references have been made to publications, patents and/or patent applications throughout this specification. Each of the cited references is individually incorporated herein by reference for its particular cited teachings as well as for all that it discloses.

What is claimed is:

1. A method comprising:
receiving a synchronized debug command;
identifying corresponding points of execution targeted by the synchronized debug command in a plurality of versions of a software application;
applying an unsynchronized debug sub-command of the synchronized debug command to the plurality of versions of the software application until the corresponding points of execution have been targeted by the unsynchronized debug sub-command in the plurality of versions of the software application.

2. The method of claim 1, wherein the synchronized debug command comprises a synchronized step command, wherein the unsynchronized debug sub-command comprises an unsynchronized step command, and wherein the unsynchronized step command is applied to the plurality of versions of the software application until the corresponding points of execution are reached.

3. The method of claim 1, wherein the synchronized debug command comprises a create breakpoint command, wherein the unsynchronized debug sub-command comprises an unsynchronized create breakpoint command, and wherein the unsynchronized create breakpoint command is applied to the corresponding points of execution of the plurality of versions of the software application.

4. The method of claim 1, wherein the plurality of versions of the software application were built from a corresponding plurality of branches of a software repository.

5. The method of claim 1, wherein each of the corresponding points of execution comprises an identification of a portion of executable code of one of the plurality of versions of the software application.

6. The method of claim 1, wherein the corresponding points of execution evolved from a common point of execution in an independent version of the software application.

7. The method of claim 2, wherein the unsynchronized step command is iteratively applied to one of the plurality of versions of the software application to step through an intermediate function not included in another one of the plurality of versions of the software application.

8. A system comprising:
a processing unit; and
a computer-readable storage medium having computer-executable instructions stored thereupon, which, when executed by the processing unit, cause the processing unit to:
receive a synchronized debug command;
identify corresponding points of execution targeted by the synchronized debug command in a plurality of versions of a software application;
apply an unsynchronized debug sub-command of the synchronized debug command to the plurality of versions of the software application until the corresponding points of execution have been targeted by the unsynchronized debug sub-command in the plurality of versions of the software application.

9. The system of claim 8, wherein the corresponding points of execution are obtained by comparing a plurality of branches of source code of the software application that correspond to the plurality of versions of the software application.

10. The system of claim 9, wherein comparing the plurality of branches comprises identifying when a function or a variable in one branch has been renamed in another branch.

11. The system of claim 8, wherein the corresponding points of execution are obtained by performing a binary comparison of executable binaries of each of the plurality of versions of the software application.

12. The system of claim 11, wherein the binary comparison determines that a remote code change or a change in a toolkit used to build the application causes instructions compiled from unchanged local code to change.

13. The system of claim 12, further comprising:
indicating that the unchanged local code compiles to different instructions in at least one of the versions of the software application.

14. The system of claim 11, wherein the binary comparison identifies that a portion of a first function has been moved to a second function, wherein the corresponding points of execution point to the first function in one of the versions of the software application and the second function in another of the versions of the software application.

15. A computer-readable storage medium having encoded thereon computer-readable instructions that when executed by a processing unit cause a system to:
receive a synchronized debug command;
identify corresponding points of execution targeted by the synchronized debug command in a plurality of versions of a software application;
apply an unsynchronized debug sub-command of the synchronized debug command to the plurality of versions of the software application until the corresponding points of execution have been targeted by the unsynchronized debug sub-command in the plurality of versions of the software application.

16. The computer-readable storage medium of claim 16, further comprising:
displaying a call stack for each of the plurality of versions of the software application.

17. The computer-readable storage medium of claim 16, wherein the call stack indicates when a name of a function or a parameter has changed between versions of the software application.

18. The computer-readable storage medium of claim 15, further comprising:
receiving a synchronized expression evaluation command;
translating variable names used in one of the plurality of versions of the software application to another of the plurality of versions of the software application; and
evaluating the synchronized expression in both versions of the software application.

19. The computer-readable storage medium of claim 15, wherein the synchronized debug command comprises a step into command, a step over command, a step out command, a run to cursor command, or a create breakpoint command.

20. The computer-readable storage medium of claim 15, wherein the computer-readable instructions further cause the system to:
generate a suggested location of point of execution from a method entry point or a method exit point.
